(19) United States
(12) Patent Application Publication
(10) Pub. No.: US 2008/0208636 A1
(43) Pub. Date: Aug. 28, 2008

(54) Keychain information tag

(75) Inventor: Ryan M. Case, Normal, IL (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Progressive Impressions International, Inc., North Mankato, MN (US)

(21) Appl. No.: 11/710,222

(22) Filed: Feb. 23, 2007

(51) Int. Cl. G06Q 40/00

(52) U.S. Cl. 705/4; 283/54

(57) ABSTRACT

An information tag is provided that enables important vehicle insurance information and identification to be kept on a keychain or analogous object, for example. In one illustrative embodiment, an information tag includes a card, an aperture in the card, and a set of content disposed on the card, wherein the content is associated with an insurance policy. Additional embodiments also include a method for providing information tags, and a sheet that includes a plurality of detachable information tags.

### BACKGROUND

Many current forms of insurance information, policy information, identification, and so forth are provided on cards of such a size that they are typically carried in one's wallet, handbag, or purse, or stored in one's car or other motor vehicle, for example. This presents some drawbacks, such as the possibilities of the owner forgetting to carry the article with him, of losing the article, of having the article stolen or its information compromised in the event that a car is broken into, and so forth. Many such forms of information or identification also typically have expiration dates and must be renewed, or have aspects of information that change periodically, or both, while the user may have no convenient way to remember to update the card. These issues are compounded in some cases such as for families with multiple drivers using multiple motor vehicles, such that they must either leave insurance information in the motor vehicles, or each carry their appropriate insurance cards with them, and each be reminded to update them when needed. These issues are also compounded in some cases such as motorcycles, where there is generally no storage space on the vehicle of a comparable level of security as the interior of a car, such that the driver has a greater need to carry an insurance card with her on her person, and constantly remember to bring the card with her when operating the motorcycle.

The discussion above is merely provided for general background information and is not intended to be used as an aid in determining the scope of the claimed subject matter.

### SUMMARY

An information tag is provided that enables important vehicle insurance information and identification to be kept on a keychain or other analogous object, for example. In one illustrative embodiment, an information tag includes a card, an aperture in the card, and a set of content disposed on the card, wherein the content is associated with an insurance policy. Additional embodiments also include a method for providing information tags, and a sheet that includes a plurality of detachable information tags, for example.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts an information tag, according to an illustrative embodiment.

FIG. 2 depicts an information tag, according to an illustrative embodiment.

FIG. 3 depicts a panel comprising a plurality of information tags, according to an illustrative embodiment.

FIG. 4 depicts a panel comprising a plurality of information tags, according to an illustrative embodiment.

FIG. 5 depicts a system for providing information tags, according to an illustrative embodiment.

FIG. 6 depicts a flowchart for a method for providing information tags, according to an illustrative embodiment.

### DETAILED DESCRIPTION

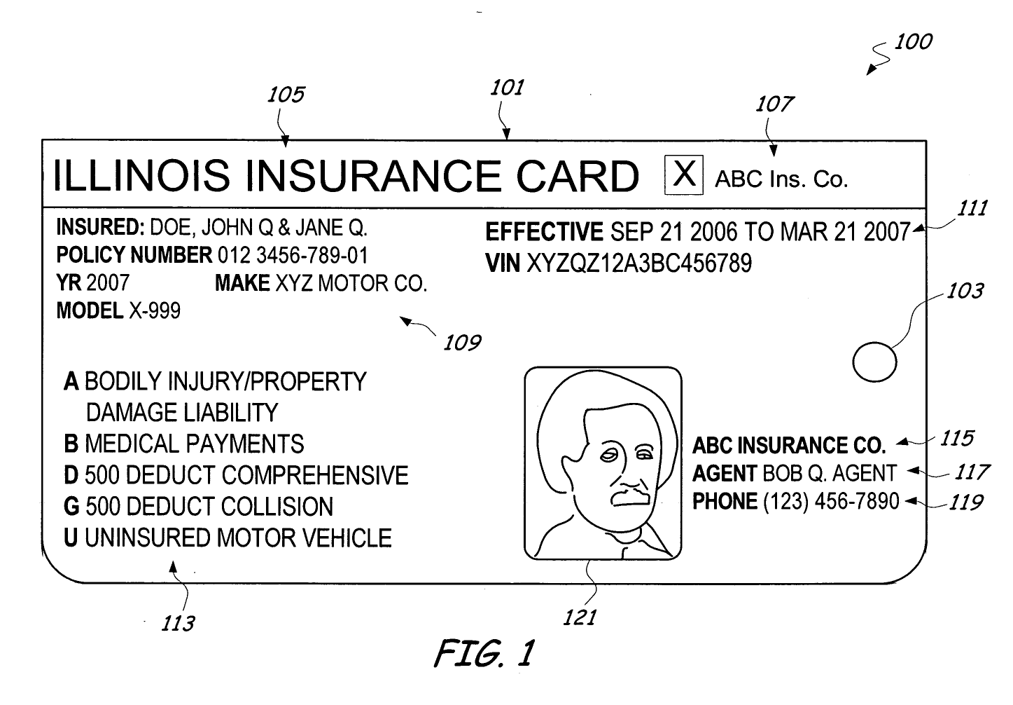

FIG. 1 depicts a tag 100, which constitutes an information tag that may be attached to an object such as a keychain, according to an illustrative embodiment. Tag 100 includes tag panel 101, and an aperture 103 through the panel. The aperture 103 is also disposed substantially proximate to an edge of the panel 101, inasmuch as it is disposed close enough to the edge of the panel 101 to make room to be attached to a chain, ring, link, or other analogous object, such as those typically used to carry one or more keys. The aperture 103 has a cross-sectional diameter, in any of a variety of shapes, sufficient to receive a typical keychain through it. In this context, a “keychain” may also illustratively include, but is not limited to, other analogous objects such as a keyring, a link, a key fob, a carabiner, or any other functionally analogous item capable of engaging one or more keys, in various embodiments. A “tag” as used herein may also illustratively include, but is not limited to, a tag, a card, or any other analogous article.

Tag 100 also includes a set of content, such as in various text sections 105, 107, 109, 111, 113, 115, 117, 119 disposed on the panel 101. Some of the content represents generalized information associated with an insurance policy, an insured individual, an insured vehicle or other object, an insurance agent, an insurance underwriter, obligor, issuer, or other provider, or some other content associated with insurance for which the tag 100 is issued. The illustrative embodiment of FIG. 1 is directed to an insurance policy for an automobile, although other embodiments may be associated with vehicular insurance for other types of vehicles such as trucks, boats, airplanes, motorcycles, bicycles, and any other type of vehicle, whether motorized or unmotorized. Similarly, while one illustrative embodiment may be directed to vehicular insurance policies, other embodiments are not limited to this example, and may include content related to any other type of insurance.

The generalized information mentioned above may include, for example, text section 105, which identifies tag 100 as an “Illinois insurance card”, thereby providing the jurisdiction in which the insurance policy is provided; and text section 107, which provides the name of an insurance provider, issuer, obligor, or underwriter that provides the insurance policy associated with tag 100, in this illustrative embodiment. This generalized information may also include, for example, additional text on either or both sides of tag panel 101 that provides instructions of steps to perform or actions to take in case of an accident, damage, theft, or traffic citation, among other things; a notice that the insurance coverage provided by the insurance policy associated with tag 100 complies with minimum liability limits prescribed by law; additional information on the coverage provided by the associated vehicle insurance policy; information desired by the agent, the insurance company, or both; or any other pertinent information, for example. In an illustrative embodiment, tag 100 may include graphical information, which may include text in part, that is preprinted by the insurance provider, obligor, underwriter, or other related entity, prior to being provided to the agent, policyholder, or insured individuals.

The text provided on tag 100 may also include individualized information associated with the policyholder or other insured individual under the vehicular insurance policy. For example, this individualized information may include text section 109, which provides the names of the policyholder clients insured by the insurance policy, the number of their policy, and the make, model, and model year of a vehicle covered by their policy; text section 111, which provides a range of dates for the period of coverage for the insurance policy, and the vehicle identification number (VIN) of the vehicle or one of the vehicles covered by the insurance policy; text section 113, which provides a basic indication of the coverage provided by the insurance policy; and text sections 115, 117, and 119, which respectively provide the name of the insurance company, issuer, underwriter, obligor, or other provider, and the name and phone number of the agent or representative of the insurance company who provided the insurance policy to the clients. These text sections may provide information on other entities with analogous roles relative to an insurance policy.

Tag 100 may also have marketing content disposed on the panel 101 thereof, the marketing content being directed to the agent, insurance company, or other type of entity associated with the vehicular insurance policy, such as the agent who provided the policy to the clients. The marketing content may take the form of image 121 of the agent, for example. It may also take the form of a logo or a slogan for the agent's business or the insurance company, or additional contact information for the agent or insurance company such as an alternate phone number, address, Web address (i.e. Uniform Resource Locator, or URL), or email address, for example. Other types of contact information or other marketing content may also be included.

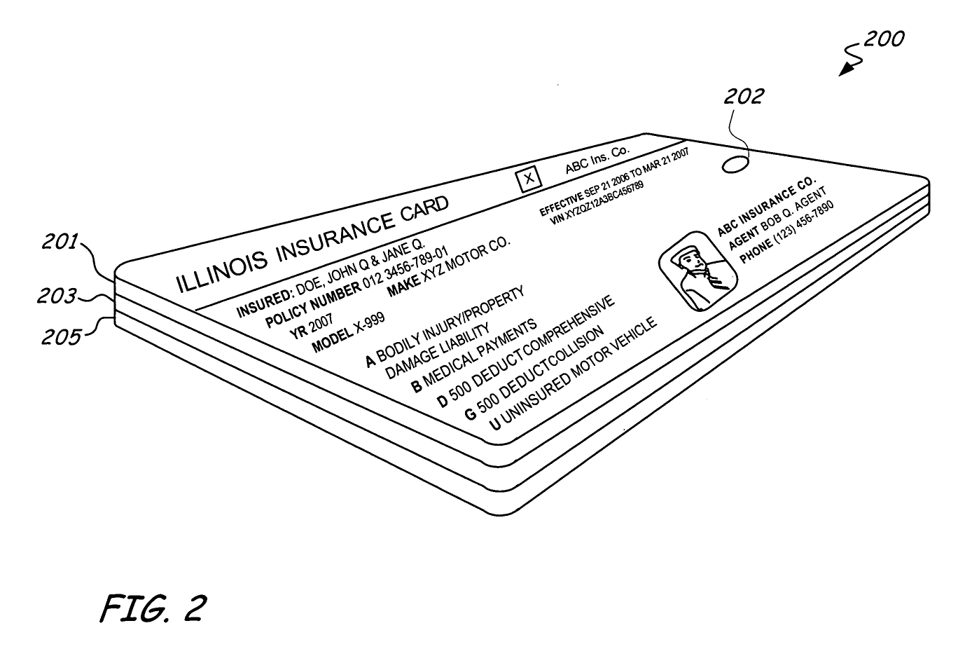

FIG. 2 depicts tag 200 that constitutes an information tag, according to an illustrative embodiment that corresponds in several respects to the embodiment of tag 100 in FIG. 1. Tag 200 is depicted in a perspective view, with a simplified depiction of the edge thereof, which demonstrates a structure of tag 200 according to an illustrative embodiment. Tag 200 may include a base layer 203, with an optional substrate 201 on one face thereof and/or an optional substrate 205 on an opposing face thereof, and an aperture 202 disposed adjacent to one edge of tag 200, the aperture 202 extending through base layer 203 and substrates 201 and 205. The substrates 201 and 205 may have the images disposed thereon comprising the text and other information or content of the tag 200. For example, in the illustrative embodiment shown in FIG. 2, substrate 201 may include information associated with the insurance policy, while substrate 205 may include additional information associated with the insurance policy (not depicted in FIG. 2) on the opposing face of tag 200. In other embodiments, various insurance-related information or other content may appear on either or both sides of tag 200, and may be provided on or within base layer 203, optional substrate 201, and/or optional substrate 205, or any combination thereof. The optional substrates 201, 205 may be transparent, to allow content from base layer 203 below them to appear readily to a viewer; they may also have content provided directly on the substrates 201 and/or 205, or in a combination of base layer and substrate. The aperture 202 or an analogous aperture may be provided through one or more of the layers of tag 200 in any combination.

The information provided on tag 200 may, for example, include information or a statement that is generally required as proof of insurance, such as vehicular liability insurance, in a jurisdiction in which the insurance policy is issued. For example, at the time of this writing, the State of California has a general requirement for a proof of insurance card to state the insurance company's name and address, the period of coverage, and the policy number; while the State of Illinois requires an insurance card issued by the insurance company to be carried in one's vehicle, but does not pose explicit requirements for the content of the card. As another illustrative example, the proof of insurance requirements of many jurisdictions may change over time, and different embodiments provided in different times may be updated to reflect those updates in the requirements of the jurisdictions in which the corresponding insurance is provided. These are provided only as illustrative embodiments and not by way of limitation; a variety of other information or combinations of information and other content may be featured in other embodiments.

In one exemplary embodiment, base layer 203 is generally composed of a material that is sufficiently durable for long-term use. For example, base layer 203 may be generally composed of a material that is of sufficient durability that an ordinary person would be unable to rip or tear it with the application of an ordinary amount of effort and strength, and without the aid of a tool; and of a sufficient durability to maintain its structural integrity over long periods of time despite the normal wear-and-tear that would be expected from being attached to a user's keychain, being placed into and pulled out of a user's pocket several times a day, and being regularly abraded by keys attached adjacent to it on a keychain throughout normal usage. For example, base layer 203, and or in addition to other components of tag 200, may be composed at least in part of polystyrene, polyethylene terephthalate, high density polyethylene, polyvinyl chloride (PVC), laminated paper, or any combination of these and other materials. In this and some other embodiments, tag 200 is provided through these and/or other means with physical characteristics that comply with at least one of the construction, the materials, or the bending stiffness specified by the ISO 7810 standard of the International Organization for Standardization, for the physical characteristics of identification cards. Other embodiments are not limited to these or any other pre-defined standards, but may take a broad variety of other forms.

Tag 200 may also include a machine-readable medium comprising information associated with the information represented in the text, or in any combination of text content and machine-readable content. For example, the machine-readable medium may include any of a linear barcode, a stacked barcode, a matrix barcode, a magnetic stripe, an integrated circuit chip, a passive radio frequency identification (RFID) tag, a semi-passive RFID tag, an active RFID tag, a programmable read-only memory (PROM), an erasable programmable read-only memory (EPROM), an electronically erasable programmable read-only memory (EEPROM), a flash memory chip, a CD, a DVD, any other type of disc, a disc drive of any type, or any other type of coded memory, such as magnetically or optically coded storage, other forms of machine-readable media, or any combination of the above. As a particular example, tag 200 may include a barcode disposed on the opposing face thereof on substrate 205, and/or an RFID tag embedded in base layer 203 (not depicted in FIG. 2), for example. Machine-readable media such as these and others may allow any portion of the content or information provided on tag 200 to be stored on tag 200 in machine-readable form. This content may also, for example, be non-encrypted or encrypted. In some illustrative embodiments, part or all of the content that may be considered confidential may be withheld from the text or other graphical content provided on tag 200, and instead be provided only in machine-readable form, and may be provided only in encrypted machine-readable form, by way of example and not limitation.

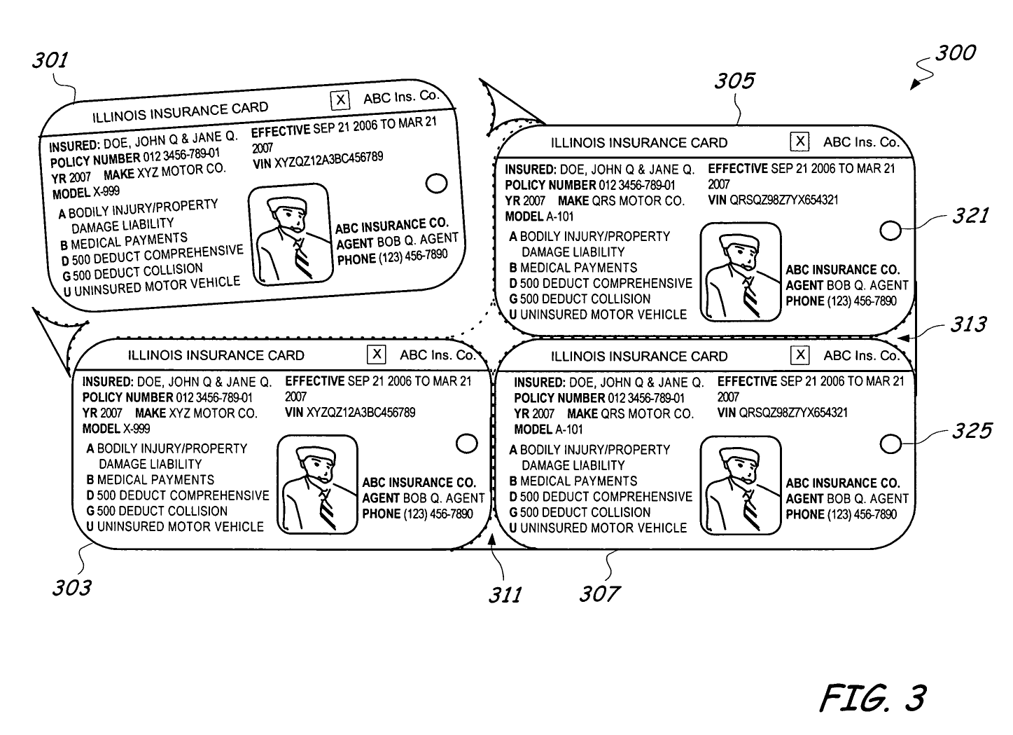

FIG. 3 depicts a sheet 300 of detachable information tag portions, according to another illustrative embodiment. Sheet 300 includes a plurality of four information tag portions 301, 303, 305, 307, arranged in an array of two rows by two columns, in this illustrative embodiment. Other embodiments are not limited to the four information tag portions of this illustrative example, but may have any number of information tag portions provided in any type of arrangement on one or several sheets. The information tag portions 301, 303, 305, 307 are defined by detachable edges, configured to enable manual separability from a remaining portion of the panel 300, such as edge 311 between tag portions 303 and 307, and edge 313 between tag portions 305 and 307, for example, in this illustrative embodiment. While illustrative edges 311, 313 are depicted as perforated in the illustrative embodiment of FIG. 3, this is only one example of an implementation in which each of the information tag portions 301, 303, 305, 307 are detachable from other portions of sheet 300 by edges that are configured to enable manual separability from a remaining portion of the panel 300. The information tag portions 301, 303, 305, 307 may also be detachable, for example, by having edges that are thinned or weakened, by any mechanism, so that a client or agent can easily separate the tag portions from the rest of the sheet by hand, with a clean separation, for example.

Each of tag portions 301, 303, 305, 307 comprises an aperture in the information tag portion, such as illustrative aperture 321 in information tag portion 301, and illustrative aperture 325 in information tag portion 305, for example. Each of the apertures 321, 325, etc. is sized to receive a keychain through it.

Each of tag portions 301, 303, 305, 307 also comprises text that provides information associated with a vehicle insurance policy. In the present illustrative embodiment, tag portions 301, 303, 305, 307 all include information relating to the same set of insured individuals covered by the same vehicle insurance policy, the policy number of the policy, the effective dates for the policy, the company that provides the insurance, the name and phone number of the agent associated with the insurance policy, an image of the agent, and basic information about the coverage provided by the policy. Information tag portions 301 and 303 provide information associated with a first vehicle covered by the vehicle insurance policy, while information tag portions 305 and 307 provide information associated with a second vehicle covered by the same vehicle insurance policy, and which applies to the same insured individuals. Information tag portions 301 and 303 therefore have indications for a first make, model, model year, and vehicle identification number (VIN) printed thereon, while information tag portions 305 and 307 have indications for a second make, model, model year, and VIN printed thereon. Other embodiments may include any number of tag portions, provided in any kind of arrangement on sheet 300.

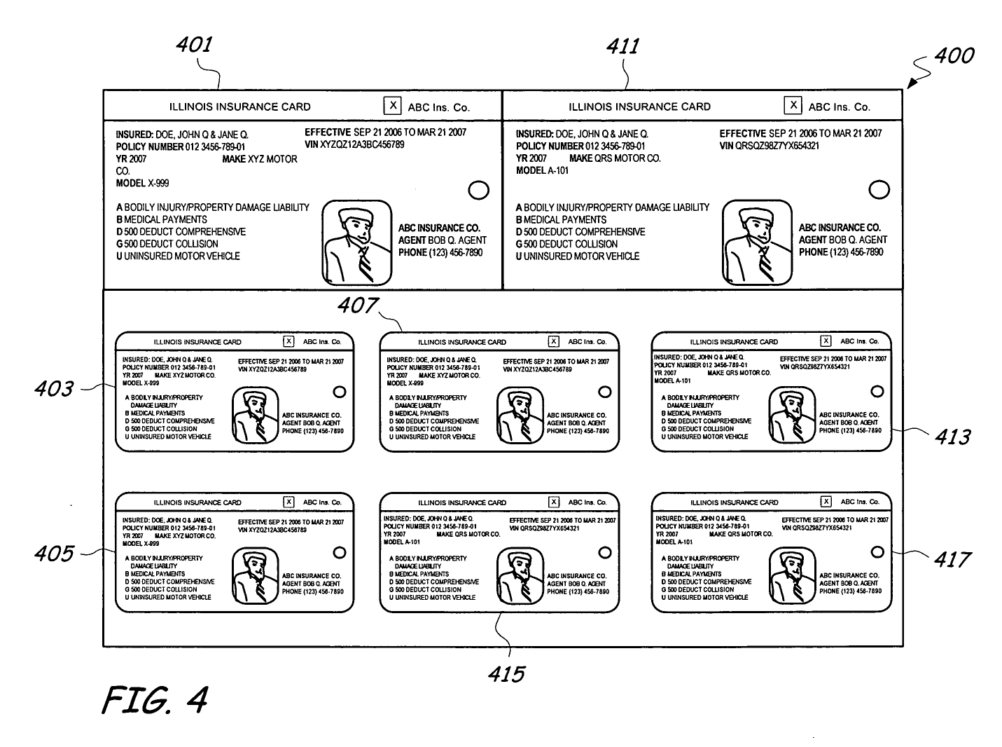

FIG. 4 depicts a sheet 400 of detachable information tag portions, according to another illustrative embodiment. Sheet 400 includes two information tag portions 401, 411 of a larger size, and six information tag portions 403, 405, 407, 413, 415, 417 of a smaller size. As in FIG. 3, this embodiment includes information tag portions for two different vehicles covered by the vehicle insurance policy: information tag portions 401, 403, 405, and 407 include text with information on a first vehicle covered under the insurance policy, while information tag portions 411, 413, 415, and 417 include text with information on a second vehicle covered under the insurance policy. The information tag portions are not depicted as perforated here, as in FIG. 3, but rather may be detachable by another means, method, or feature, illustratively such as having edges that are thinned or weakened, for example, to provide an easy, clean break when the information tag portions are separated by hand into separate information tags. The information tag portions may also be either part of the same material as the sheet, or separate units that are tipped on, adhered, glued, or otherwise disposed on the sheet as a backing, and may be removed from the sheet. In yet another embodiment, the edges are not provided with thinning or weakening features or otherwise made particularly conducive to detachment, and the information tag portions instead may be removed by a cutting or separating method or means configured for making clean separations through the normal durability of the material of which the sheet is composed. Still other embodiments may be provided that are separable with the aid of a tool, or that have various other modes for separating the tag portions from the sheet.

In one illustrative embodiment, the larger information tag portions 401, 411 may be sized appropriately to comply with the size specified by the CR-80/ISO 7810 ID-1 standard, known alternately as CR-80, and as ISO 7810 ID-1 as published by the International Organization for Standardization (ISO). The size specified by this standard is 85.60 millimeters by 53.98 millimeters, the equivalent to approximately three and three-eighths inches by two and one-eighth inches, and is popularly used for typical, wallet-sized credit cards, debit cards, and the like. Other embodiments may be provided in a variety of sizes larger and smaller than this illustrative example. Larger information tag portions 401, 411 may be provided with apertures, as shown in FIG. 4, or without apertures, as may other sizes of information tag portions, in various embodiments.

In the illustrative embodiment of FIG. 4, the six other information tag portions 403, 405, 407, 413, 415, 417 are substantially smaller than the size specified by the CR-80/ISO 7810 ID-1 standard. As one illustrative example, these smaller information tag portions may be sized appropriately to comply with the size specified by the ISO 7810 ID-000 standard, i.e. 25 millimeters by 15 millimeters. In other embodiments, the smaller information tag portions may have a variety of other sizes, that may be smaller or larger than this standard. Any of these sizes may be applicable to the sheet 300 described above in connection with FIG. 3, and any of these sizes may constitute an information tag or card for an insurance policy. While certain designs, layouts, and combinations of numbers and sizes of information tag portions are depicted in FIGS. 3 and 4, it is to be well understood that these are merely illustrative of the broad variety of any manner of different permutations of numbers, sizes, and combinations with other features that may be provided on one or more sheets, in different embodiments.

In this and other examples, one or more of the larger-sized information tag portions 401, 411 may be separated from sheet 400 and stored by an insured individual under the vehicle insurance policy in the individual's wallet, handbag, or purse, or in the glove compartment or other compartment of a vehicle covered under the insurance policy; while one or more of the smaller-sized information tag portions may be separated from sheet 400 and attached to the covered individual's keychain, so that the insured individual will be more likely to have this smaller, insurance information keychain card or tag always with her, than if she has wallet-sized insurance information cards only. In particular, if an insured individual keeps one of the keychain-sized insurance information cards or tags on the same keychain (or equivalent device) on which he keeps his key to a vehicle covered by the insurance policy associated with the information tag, this can virtually ensure that he will always have the insurance information when he needs it, whether or not he happens to remember to bring a larger information card that is habitually kept in a separate place, whether a wallet that might be left at home, or even a glove compartment that might be cleaned out and its proper contents not replaced.

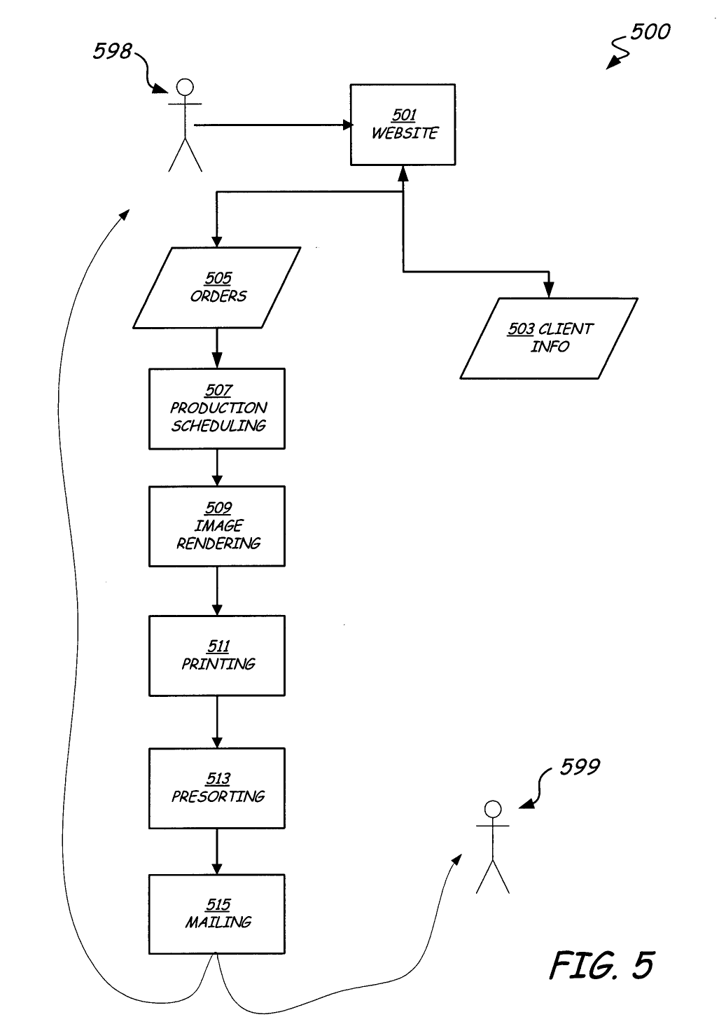

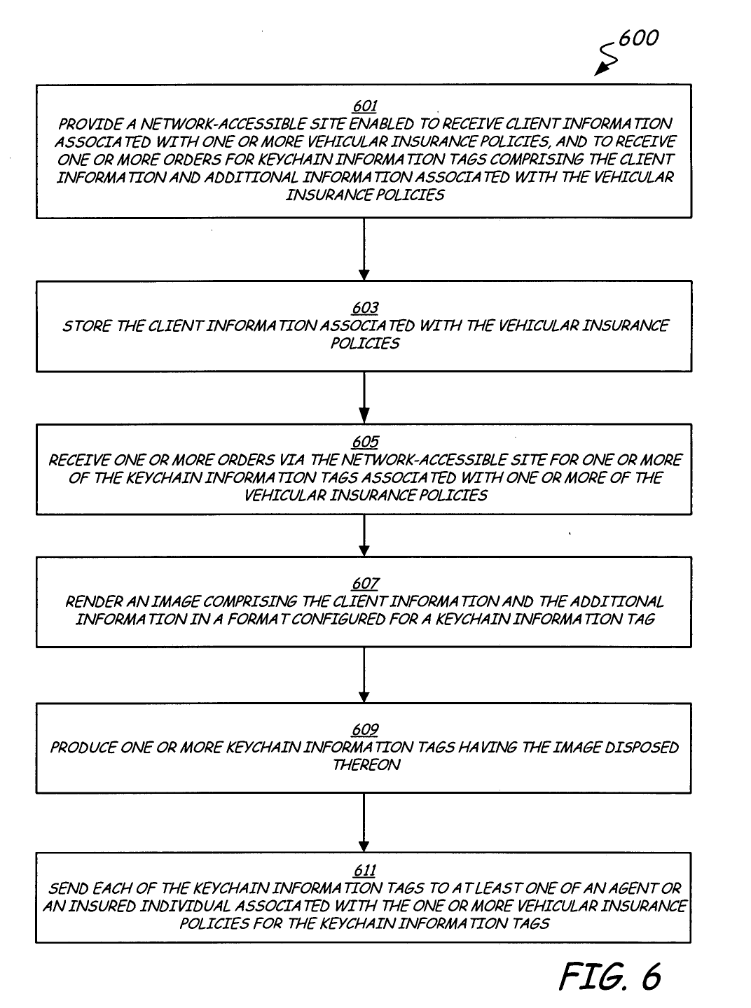

FIG. 5 depicts a system 500 for ordering and providing information tags or cards. FIG. 6 depicts a flowchart for a method 600 of using system 500 for ordering and providing information tags. Step 601 includes providing a network-accessible site, such as website 501, enabled to receive client information associated with one or more vehicular insurance policies, and to receive one or more orders for information tags comprising the client information and additional information associated with the vehicular insurance policies. For example, website 501 may be made available to user 598, who may be an insurance agent associated with contracting with a policyholder for the vehicle insurance policy. User 598 who is provided access to website 501 may also be the policyholder herself, or another insured individual covered by the vehicle insurance policy, or employees of a third-party contracting service, or employees of a company that provides or underwrites the vehicle insurance policy, for example. A policyholder or another insured individual who is not personally a holder of the policy, may be considered a client and a subject of the client information, while vehicles covered by a policy, and other related information, may also be considered client information.

Step 603 includes storing the client information 503 associated with the vehicular insurance policies. For example, the client information may be stored on a local or a secure, network-accessible database.

Step 605 includes receiving one or more orders 505 via the network-accessible site 501 for one or more of the information tags associated with one or more of the vehicular insurance policies. Such orders 505 may be placed within the same access event in which user 598 enters the client information 503, such that the client information can be used for the order while it is still in the local computer's short-term memory after having been entered; or, the orders 505 may be placed much later, and the client information 503 retrieved from long-term, non-volatile storage. Orders may be carried out immediately and the corresponding tags may be produced within a single process as the event in which one of the orders 505 is placed; or the orders may also be subject to longer-term production scheduling 507, as when a larger number of orders are saved and then produced in a larger batch, or when renewed tags are produced, for example. This may also include an agent or other user 598 making changes at any time to the content of the information tags, such that changes may be made in the content of tags about to be produced, or changes to the content may be stored, and may be changed again, before being incorporated into a new set of tags produced at a later time. Such changes may be of any nature; examples may include updates to contact information, or changes in the details of items or people being covered by an insurance policy, or changes in advertising or marketing content provided on the tags. Other changes may also be made that are not limited to these illustrative examples.

Step 607 includes rendering an image comprising the client information and the additional information in a format configured for an information tag, as with image rendering module 509. Rendering the image for the information tag includes combining all or part of the information needed for a given information card or information tag or combination thereof. The image can be formatted and rendered for a single information card or tag of any of a variety of sizes, or they can be rendered for an array of information cards or tags of one or more sizes, in any combination, to be printed together on a sheet, including such as the sheets of FIGS. 3 and 4.

Step 609 includes producing one or more information tags having the image disposed thereon, such as at printing module 511, for example. Any of a wide variety of printing or other mechanisms may be used for producing the information tags or cards with the image, in different embodiments.

Step 611 includes sending each of the information tags to at least one of an agent or an insured individual associated with the vehicular insurance policies for the information tags, for example. This may include a process of presorting 513, to sort all the information cards in a batch into their proper addresses or other destination indicators; and a process of mailing 515, using any of a variety of postal or delivery services to send the insurance information cards to their proper destinations, such as to user 598, who may be an agent, or to recipient 599, who may be an insured individual, for example.

As described above, the client information 503 may be stored for later retrieval. It may also be updated at later times, as needed; for example, when a policyholder adds a new vehicle to the policy, or takes an old vehicle off the policy. The policyholder may also add a new insured individual to the policy, such as a new employee for a company fleet, or a teenage child of the policyholder; or the policyholder may opt to change a deductible. The client information may also be updated from time to time, which may include automatic or manual scheduled updates, or additional changes that may be introduced as needed or at any time. For example in one illustrative example, a scheduled update may be set to recur regularly, such as every six months, simply to reflect a new range of effective dates for the policy to be in effect, as an old range of dates expires and the policyholder pays for the policy to be renewed. In the same example, an agent, company representative, or other responsible party may enter a change at a random time between the scheduled changes, to update new information about the insurance once it has become available. This may be on top of the scheduled change, or may include altering or suspending the scheduled changes. Other embodiments may also enable any combination of regular and irregular changes to be made.

At any time after the client information 503 has been stored, a new order 505 for insurance information tags may be received through network-accessible site 501. In response to the new order, any needed updates to the client information 503 may be incorporated in rendering an updated image for the insurance information tag. New information tags may then be produced using the updated image disposed thereon, complete with updated client information and the appropriate additional information, combined in a format for the size of information tag or tags that are ordered.

As with the sheets depicted in FIGS. 3 and 4, the method 600 can format and render the images in a configuration for several information tags to be produced per sheet, such that the image portions corresponding to the individual information tags are printed or otherwise produced on detachable sections of the sheet. The order may specify a certain number of each available size, or any combination of custom-selected sizes for the information tags, and the tags may be produced in those selected sizes for each order. After the imaged sheets are produced, they may be divided up, as whole sheets or sections of sheets as needed, such that the information tags provided on the sheets, and/or individual information tags, are pre-sorted according to different destinations corresponding to different insured individuals, to be sent to the insured individuals themselves, to just the policyholders, to the agents, to some other responsible parties, or any combination thereof.

For example, a single sheet may include insurance tag portions that include information pertaining to different vehicles covered under the same insurance policy, such as cards for the same set of drivers in one family but for different cars belonging to a household, a family, or a common group of some other type, in one illustrative example. In another example, a single sheet may include insurance tag portions that include information pertaining to different insured individuals covered under the same insurance policy, such as for different individuals who are insured as drivers of cars in a company fleet, as one illustrative example. In another example, one sheet may contain insurance tag portions directed to different vehicles and different insured individuals, or to different insurance policies, such as for sheets being sent to an insurance agent to provide to different client policyholders who are not connected with each other, in an illustrative embodiment. The above examples are illustrative only though and do not represent limitations from other potential forms of information. Different sheets may include any combination of these sets of information on different insurance tag portions, and are not limited to these combinations but may also include other kinds or combinations of information.

Although the subject matter has been described in language specific to structural features and/or methodological acts, it is to be understood that the subject matter defined in the appended claims is not limited to the specific illustrative features or acts described above. A broad variety of other structures may be disposed on an information card or information tag portion for receiving a keychain, including a loop, a clip, and any other conducive structure, which may be made of the same or a different material as one that composes all or part of the remainder of the information card or tag, for example. The elements defined by the claims may be embodied according to these and other innovative advances while still remaining consistent with and encompassed by the elements defined by the claims herein.

What is claimed is:

1. An information tag comprising:
a card;
an aperture in the card; and
a set of content disposed on the card, wherein the content is associated with an insurance policy.

2. The information tag of claim 1, wherein the content associated with the insurance policy comprises at least one element selected from among the group consisting of: a name of at least one insured individual covered by the insurance policy, a policy number of the insurance policy, a range of effective dates for the insurance policy, a make of a vehicle covered by the insurance policy, a model of a vehicle covered by the insurance policy, a model year of a vehicle covered by the insurance policy, a vehicle identification number of a vehicle covered by the insurance policy, aspects of coverage provided by the insurance policy, deductible amounts associated with the insurance policy, a name of an insurance company that provides the insurance policy, a name of a jurisdiction in which the insurance policy is provided, and the information or statement generally required to serve as proof of insurance in the jurisdiction in which the insurance policy is provided.

3. The information tag of claim 1, further comprising marketing content disposed on the card, the marketing content being directed to an entity associated with the insurance policy, comprising at least one of: a name of an agent, an image of an agent, a phone number of the entity, an address of the entity, a Web address of the entity, an email address of the entity, or a business logo associated with the entity.

4. The information tag of claim 1, wherein the aperture is disposed substantially proximate to an edge of the card.

5. The information tag of claim 1, wherein the card is composed at least in part of a composition selected from among polystyrene, polyethylene terephthalate, high density polyethylene, polyvinyl chloride, and laminated paper.

6. The information tag of claim 1, wherein the card has physical characteristics that comply with at least one of construction, materials, or bending stiffness specified by the ISO 7810 standard.

7. The information tag of claim 1, wherein the information tag is substantially smaller in at least one dimension than a respective dimension specified by the CR-80/ISO 7810 ID-1 standard.

8. The information tag of claim 1, wherein the information tag complies with a size specified by the ISO 7810 ID-000 standard.

9. The information tag of claim 1, wherein the card further comprises:
a first face, comprising a first substrate; and
a second face, disposed opposite the first face, the second face comprising a second substrate;
wherein the content associated with the insurance policy is disposed on one or both of the substrates.

10. The information tag of claim 1, further comprising a machine-readable medium comprising information associated with the content disposed on the card.

11. The information tag of claim 10, wherein the machine-readable medium is selected from among a linear barcode, a stacked barcode, a matrix barcode, a magnetic stripe, an integrated circuit chip, a passive radio frequency identification tag, a semi-passive radio frequency identification tag, an active radio frequency identification tag, a programmable read-only memory (PROM), an erasable programmable read-only memory (EPROM), an electronically erasable programmable read-only memory (EEPROM), a flash memory chip, a CD, a DVD, a disc, a disc drive, or another type of magnetically or optically coded memory.

12. The information tag of claim 1, wherein the content is associated with a vehicular insurance policy.

13. The information tag of claim 1, wherein the aperture has a diameter sufficient to receive a keychain.

14. A method comprising:
providing a network-accessible site enabled to receive client information associated with one or more insurance policies, and to receive one or more orders for information tags comprising the client information and additional information associated with the insurance policies;
storing the client information associated with the insurance policies;
receiving one or more orders via the network-accessible site for one or more of the information tags associated with one or more of the insurance policies;
rendering an image comprising the client information and the additional information in a format configured for an information tag;
producing one or more information tags having the image disposed thereon; and
sending each of the information tags to at least one of an agent or an insured individual associated with the one or more insurance policies for the information tags.

15. The method of claim 14, further comprising:
receiving updates to the client information associated with one or more of the insurance policies;
responding to a subsequent order for one or more of the information tags associated with the updated client information by rendering an updated image comprising the updated client information and the additional information in a format configured for an information tag; and
producing one or more information tags having the updated image disposed thereon.

16. The method of claim 14, wherein the format is configured for a plurality of the information tags to be printed on one sheet, and the one or more information tags are produced as detachable sections of the sheet.

17. The method of claim 14, further comprising pre-sorting the information tags for a plurality of the insured individuals according to different destinations to which to send the information tags.

18. The method of claim 14, wherein the network-accessible site is further enabled to receive one or more custom-selected sizes for the information tags, and wherein the information tags are produced in the one or more custom-selected sizes.

19. The method of claim 14, wherein the insurance policies comprise vehicular insurance policies.

20. The method of claim 14, wherein each of the one or more information tags comprises an aperture having a diameter sufficient to receive a keychain.

21. A sheet comprising two or more information tag portions, wherein the information tag portions are detachable from a remaining portion of the sheet, wherein each of the information tag portions comprises:
an aperture in the information tag portion; and
information associated with an insurance policy.

22. The sheet of claim 21, wherein the information tag portions are detachable from the remaining portion of the sheet along a thinned, weakened, or perforated edge.

23. The sheet of claim 21, wherein one or more of the information tag portions comprises information associated with a first vehicle covered by the insurance policy, and one or more of the information tag portions comprises information associated with a second vehicle covered by the insurance policy.

24. The sheet of claim 21, wherein one or more of the information tag portions comprises information associated with a first insured individual covered by the insurance policy, and one or more of the information tag portions comprises information associated with a second insured individual covered by the insurance policy.

25. The sheet of claim 21, wherein one or more of the information tag portions comprises information associated with a first insurance policy, and one or more of the information tag portions comprises information associated with a second insurance policy.

26. The sheet of claim 21, wherein one or more of the information tag portions comprised on the sheet complies with the size specified by the CR-80/ISO 7810 ID-1 standard, and one or more of the information tag portions comprised on the sheet is substantially smaller in at least one dimension than the size specified by the CR-80/ISO 7810 ID-1 standard in the at least one dimension.

27. The sheet of claim 21, wherein the sheet comprises at least four of the information tag portions, arranged in an array of at least two rows by at least two columns.
